(19) United States
(12) Patent Application Publication
(10) Pub. No.: US 2026/0135714 A1
(43) Pub. Date: May 14, 2026

(54) Unified Governance Platform with Cryptographic State Enforcement and Secure Interoperability

(71) Applicant: George William Bickerstaff, III, Greenwich, CT (US)

(72) Inventor: George William Bickerstaff, III, Greenwich, CT (US)

(21) Appl. No.: 19/439,302

(22) Filed: Jan. 3, 2026

(51) Int. Cl. H04L 9/32

(52) U.S. Cl. CPC H04L 9/3247

(57) ABSTRACT

A platform enforces cryptographically verifiable governance state transitions across Web2 and Web3 ecosystems using a finite state machine and a hierarchy of secure execution environments, integrating a state engine, integration layer, security module, constraint enforcement module, and conflict resolution module. It ensures compliance, security, and scalability through simplified execution and rule-based conflict resolution, adaptable to future standards. The platform supports decentralized finance, enterprise systems, and autonomous systems with governance enforcement and EOU for monetization.

### CROSS-REFERENCE TO RELATED APPLICATIONS

This application claims the benefit of U.S. Provisional Patent Application No. 63/999,123, filed Jan. 2, 2026, the entire contents of which are incorporated herein by reference.

This application incorporates by reference the following published U.S. patent applications:
Influence Forecasting Engine for Predictive Influence Trajectory Modeling (Pub. No. US-2025-0392470-A1, filed Aug. 21, 2025, published Dec. 25, 2025).
Decentralized Stakeholder Voting Layer for Trust-Weighted Blockchain Governance (Pub. No. US-2025-0391219-A1, filed Aug. 26, 2025, published Dec. 25, 2025).
Influence Risk Engine for Predicting and Mitigating Reputational and Strategic Influence Exposure (Pub. No. US-2026-0004218-A1, filed Aug. 22, 2025, published Jan. 1, 2026).
Reinforcement Learning Engine for Adaptive Influence Optimization (Pub. No. US-2026-0004197-A1, filed Aug. 26, 2025, published Jan. 1, 2026).

### STATEMENT REGARDING FEDERALLY SPONSORED RESEARCH OR DEVELOPMENT

Not applicable.

### INCORPORATION BY REFERENCE

None.

### BACKGROUND OF THE INVENTION

### Field of the Invention

The invention relates to distributed computing and cryptographic governance enforcement. It provides a platform for enforcing cryptographically verifiable state transitions across Web2 and Web3 ecosystems using flexible execution environments. The platform ensures compliance, security, and monetization, adaptable to future technologies.

### Background

Existing systems for predictive modeling or trust-weighted voting lack flexible state enforcement across ecosystems. Risk mitigation and optimization systems exist but do not integrate accessible conflict resolution or adaptable cryptography. A platform is needed for streamlined governance with secure, future-proof interoperability.

### SUMMARY OF THE INVENTION

The invention provides a platform for enforcing cryptographically verifiable governance state transitions across Web2 and Web3 ecosystems using a hierarchy of execution environments. It includes a governance state engine, integration layer, security module, constraint enforcement module, and conflict resolution module with Evidence of Use (EoU) logging, designed for future adaptability. The platform ensures compliance, security, and monetization with simplified implementation.

### Definitions

For clarity, the following terms are defined:
Constraint Enforcement: Validation of state transitions against regulatory, sustainability, and risk parameters.
Cross-Ecosystem Integration: Data exchange between Web2 (e.g., ERP systems) and Web3 (e.g., Ethereum) platforms using APIs.
Cross-Jurisdictional Conflict Resolution: Rule-based resolution of regulatory conflicts (e.g., GDPR vs. PIPL).
Governance State Machine: Finite states (e.g., Normal Operation, Emergency Suspension) with defined transitions.
Secure Execution Environment: An execution context including one or more of: (a) software-based cryptographic modules, (b) hardware-isolated secure enclaves, (c) Trusted Execution Environments (TEEs), wherein enforcement guarantees increase with isolation.
Future-Proof Interoperability: Data transfer protected by cryptographic algorithms adaptable to emerging standards.

### BRIEF DESCRIPTION OF THE DRAWINGS

The drawings illustrate the invention's embodiments:

FIG. 1: GOVERNANCE STATE MACHINE ARCHITECTURE

The platform enforces state transitions using secure execution environments across ecosystems. It integrates cryptographic security and compliance with EoU logging. The system supports future protocols with simplified control.

FIG. 1A: GOVERNANCE STATE ENGINE

Maintains finite states with transitions in secure environments. Enforces reversible and irreversible transitions cryptographically. Adapts to future governance protocols.

FIG. 1B: CROSS-ECOSYSTEM INTEGRATION LAYER

Harmonizes schemas using APIs. Enables state propagation with EOU logging. Supports emerging ecosystems.

FIG. 1C: SECURITY MODULE

Implements cryptographic enforcement within secure execution environments. Secures state transitions against threats. Ensures future-proof execution.

FIG. 1D: CONSTRAINT ENFORCEMENT MODULE

Validates transitions against compliance in secure environments. Rejects non-compliant states cryptographically. Adapts to future regulations.

FIG. 1E: CONFLICT RESOLUTION MODULE

Resolves conflicts using rule-based hierarchy, logged for EoU. Supports future regulatory frameworks. Ensures system integrity.

FIG. 2: STATE TRANSITION WORKFLOW

Enforces transitions with cryptographic validation in secure environments. AI proposals are subordinate to constraint gates with EoU logging. Non-compliant transitions are rejected and audited.

FIG. 2A: STATE PROPOSAL GENERATION

AI proposes transitions within bounded parameters, discarded if constraints fail. Logs proposals for EoU to track usage. Ensures simplified innovation.

FIG. 2B: CONSTRAINT VALIDATION

Validates proposals against constraints in secure environments. Rejects non-compliant transitions, logged for EoU. Adapts to future standards.

FIG. 2C: CRYPTOGRAPHIC ENFORCEMENT

Executes transitions with adaptable cryptography in secure environments. Ensures tamper-proof execution. Supports trust across ecosystems.

FIG. 2D: CONFLICT RESOLUTION PROCESS

Resolves conflicts with rule-based hierarchy, logged for EoU. Triggers state freeze for disputes. Adapts to future regulations.

FIG. 2E: AUDIT AND EVIDENCE OF USE LOGGING

Logs transitions for audits and EoU in secure environments. Ensures future compliance. Supports infringement detection.

FIG. 3: CONSTRAINT ENFORCEMENT PROCESS

Enforces compliance and risk as gates in secure environments. Rejects non-compliant transitions with adaptable validation. Resolves conflicts for future frameworks.

FIG. 3A: REGULATORY CONSTRAINT GATE

Blocks regulatory violations in secure environments. Updates constraints dynamically. Adapts to future laws.

FIG. 3B: SUSTAINABILITY CONSTRAINT GATE

Rejects transitions exceeding environmental thresholds. Computes metrics for compliance. Aligns with future standards.

FIG. 3C: RISK CONSTRAINT GATE

Blocks high-risk transitions in secure environments. Stabilizes outcomes. Ensures reliability across technologies.

FIG. 3D: AI CONSTRAINT GATE

Limits AI proposals in secure environments, discarding non-compliant proposals. Logs for EoU. Subordinates AI to enforcement.

FIG. 3E: CONFLICT RESOLUTION GATE

Resolves regulatory conflicts, logged for EoU. Freezes states for disputes. Adapts to future frameworks.

FIG. 4: CROSS-ECOSYSTEM PROPAGATION

Propagates transitions across Web2 and Web3 in secure environments. Enforces consistency with EoU logging. Supports future protocols.

FIG. 4A: WEB2 INTEGRATION

Propagates states to ERP systems via APIs with EOU logging. Uses schema mapping. Supports future systems.

FIG. 4B: WEB3 INTEGRATION

Propagates states to blockchains with EOU logging. Ensures trust and scalability. Supports future protocols.

FIG. 4C: SECURE PROPAGATION

Secures propagation with adaptable cryptography. Prevents tampering. Future-proofs interoperability.

FIG. 4D: FORK RESOLUTION PROCESS

Determines canonical states across forks, logged for EoU. Enforces consistency. Adapts to future architectures.

FIG. 4E: COMPLIANCE SYNCHRONIZATION

Synchronizes constraints dynamically. Updates rules for future regulations. Ensures adherence.

FIG. 5: GOVERNANCE CONTROL INTERFACE

Displays states and constraints with restricted inputs. Executes controls with EoU logging. Supports future technologies.

FIG. 5A: STATE VISUALIZATION

Displays states and transitions in real-time. Enhances clarity for operators. Supports future interfaces.

FIG. 5B: CONSTRAINT STATUS DASHBOARD

Visualizes compliance and risk, highlighting rejected transitions. Supports monitoring for future systems. Ensures operational transparency.

FIG. 5C: CONFLICT RESOLUTION LOG

Displays conflict outcomes, logged for EoU. Records freeze actions. Ensures transparency.

FIG. 5D: AUDIT AND EVIDENCE OF USE INTERFACE

Provides access to logs for audits and EoU. Ensures future compliance. Supports infringement detection.

FIG. 5E: SECURE API ENDPOINT

Delivers data via APIs, logged for EoU. Restricts unauthorized access. Supports future protocols.

### DETAILED DESCRIPTION OF THE INVENTION

### System Overview

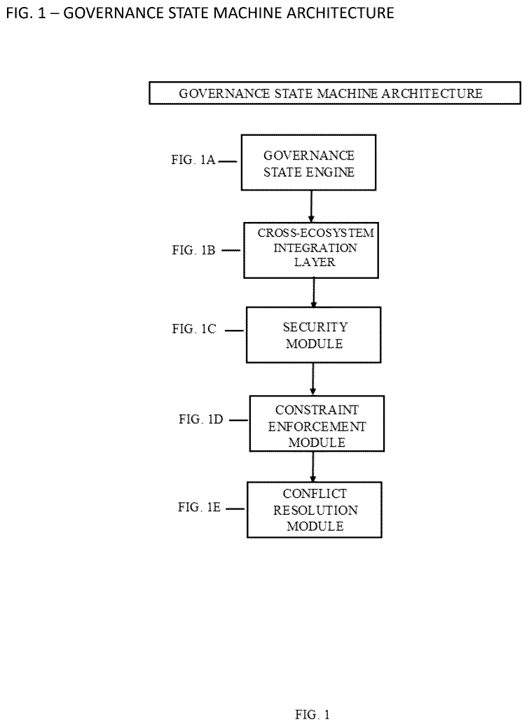

Referring to FIG. 1, the platform (100) comprises five modules: Governance State Engine (110), Cross-Ecosystem Integration Layer (120), Security Module (130), Constraint Enforcement Module (140), and Conflict Resolution Module (150). It enforces cryptographically verifiable state transitions using a hierarchy of secure execution environments, building on prior art (US-2025-0392470-A1, US-2025-0391219-A1, US-2026-0004218-A1, US-2026-0004197-A1). The platform ensures compliance, security, and monetization, adaptable to future technologies.

### Governance State Enumeration

The governance state engine maintains finite states:
State ID: Normal Operation, Regulatory Constraint, Elevated Risk, Monetization-Restricted, Emergency Suspension.
Permitted Transitions: Normal to Regulatory Constraint; Elevated Risk to Emergency Suspension.
Prohibited Transitions: Emergency Suspension to Normal without override.
Required Constraints: Regulatory (e.g., GDPR, PIPL), Sustainability, Risk.
Cryptographic Requirements: Signatures in secure execution environments, adaptable to future standards.
Irreversibility Flag: Certain states are cryptographically irreversible absent an authenticated override transition executed within a secure execution environment. This ensures simplified control and continuation potential for future state definitions.

FIG. 1A: GOVERNANCE STATE ENGINE

The state engine (110) maintains finite states in secure execution environments, enforcing reversible and irreversible transitions cryptographically. It supports simplified governance control. The module integrates with future protocols.

FIG. 1B: CROSS-ECOSYSTEM INTEGRATION LAYER

The integration layer (120) harmonizes schemas using ontology-driven APIs, as in prior art. It enables state propagation with EoU logging. The layer supports emerging ecosystems.

FIG. 1C: SECURITY MODULE

The security module (130) implements cryptographic enforcement within one or more secure execution environments, adaptable to future standards. It protects state transitions against emerging threats. The module ensures tamper-proof execution.

FIG. 1D: CONSTRAINT ENFORCEMENT MODULE

The enforcement module (140) validates transitions against regulatory and risk constraints in secure execution environments. It rejects non-compliant states cryptographically.

The module adapts to future regulations.

FIG. 1E: CONFLICT RESOLUTION MODULE

The resolution module (150) resolves conflicts using a rule-based hierarchy, logging for EoU. It supports adaptation to future regulatory frameworks. The module ensures system integrity.

### State Transition Workflow

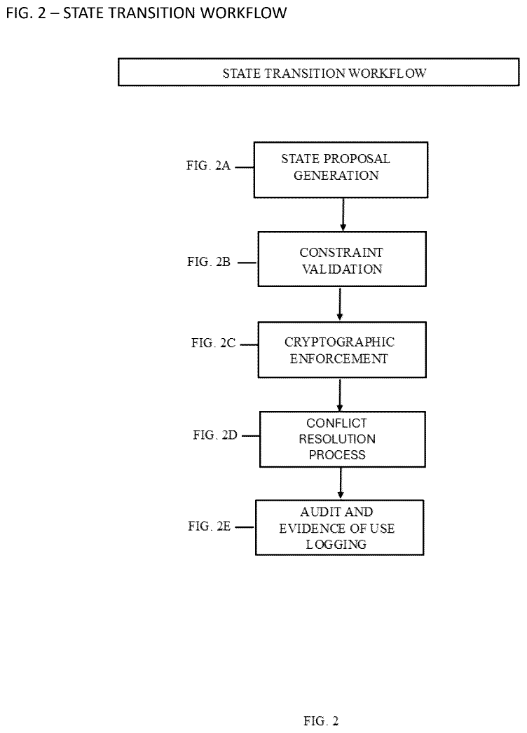

FIG. 2 illustrates the state transition workflow in secure execution environments. Proposals are validated, enforced cryptographically, and audited with EOU logging. Non-compliant transitions are rejected.

FIG. 2A: STATE PROPOSAL GENERATION

AI proposes transitions within bounded parameters, with no authority to effect state transitions and discarded without execution upon failure of any constraint gate, logged for EoU. The process ensures simplified innovation. It integrates with prior art for proposal generation.

FIG. 2B: CONSTRAINT VALIDATION

Proposals are validated against constraints in secure execution environments. Non-compliant transitions are rejected, logged for EOU. The module adapts to future standards.

FIG. 2C: CRYPTOGRAPHIC ENFORCEMENT

Approved transitions are executed with adaptable cryptography in secure execution environments. The module ensures tamper-proof execution. It supports trust across ecosystems.

FIG. 2D: CONFLICT RESOLUTION PROCESS

Conflicts are resolved with a rule-based hierarchy, logged for EOU. The module triggers state freeze for disputes and adapts to future regulations. It maintains governance integrity.

FIG. 2E: AUDIT AND EVIDENCE OF USE LOGGING

Transitions are logged for audits and EoU in secure execution environments. The module ensures compliance with future standards. It supports infringement detection.

### Constraint Enforcement Process

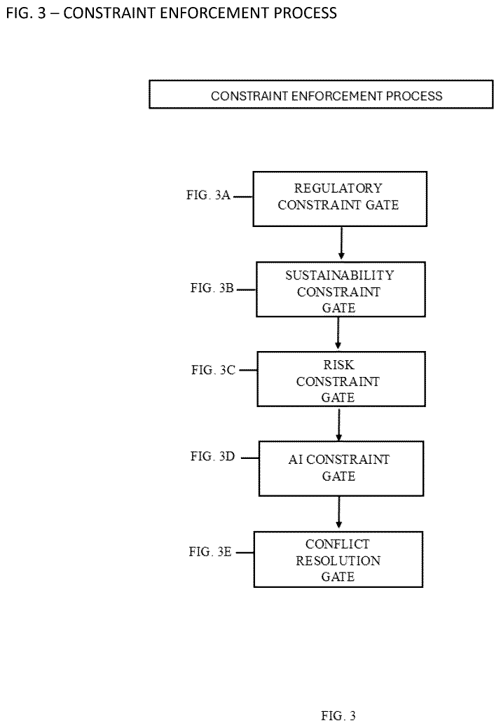

FIG. 3 details constraint enforcement in secure execution environments. Compliance and risk act as gates with adaptable validation. Conflicts are resolved for future frameworks.

FIG. 3A: REGULATORY CONSTRAINT GATE

The gate blocks regulatory violations (e.g., GDPR, PIPL) in secure execution environments. It updates constraints dynamically for future laws. The module ensures compliance.

FIG. 3B: SUSTAINABILITY CONSTRAINT GATE

The gate rejects transitions exceeding environmental thresholds. It computes metrics for compliance with future standards. The module aligns with emerging regulations.

FIG. 3C: RISK CONSTRAINT GATE

The gate blocks high-risk transitions in secure execution environments. It stabilizes governance outcomes across technologies. The module ensures reliability.

FIG. 3D: AI CONSTRAINT GATE

The gate limits AI proposals in secure execution environments, discarding non-compliant proposals without execution, logged for EoU. It subordinates AI to enforcement. The module supports future AI frameworks.

FIG. 3E: CONFLICT RESOLUTION GATE

The gate resolves regulatory conflicts, logged for EoU. It freezes states for disputes and adapts to future frameworks. The module ensures compliance.

Constraint Enforcement with Hardware Escalation

In one or more embodiments, enforcement escalates from software-based secure modules to hardware-isolated execution environments when predefined risk, compliance, or jurisdictional thresholds are exceeded. This escalation ensures enhanced cryptographic integrity for critical transitions. The approach aligns with future hardware advancements.

### Cross-Ecosystem Propagation

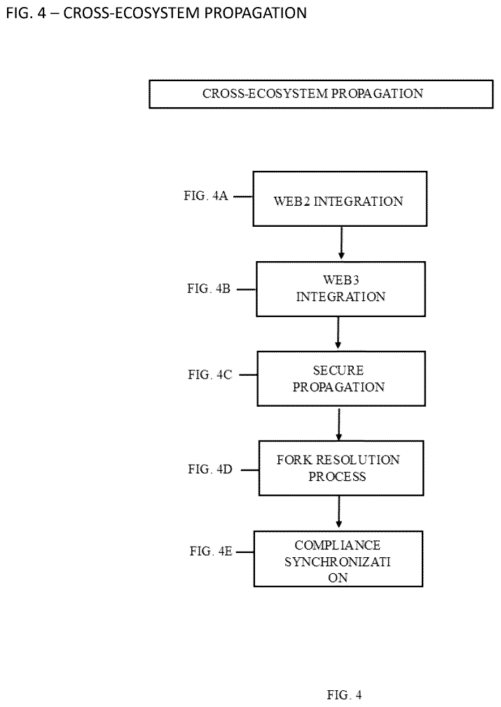

FIG. 4 illustrates state propagation in secure execution environments. Transitions are cryptographically enforced with EoU logging. The system supports future ecosystem protocols.

FIG. 4A: WEB2 INTEGRATION

States propagate to ERP systems via APIs with EoU logging. Schema mapping ensures compatibility with future systems. The module supports integration.

FIG. 4B: WEB3 INTEGRATION

States propagate to blockchains with EOU logging, ensuring trust and scalability. The module supports future blockchain protocols. It integrates with prior art for Web3 compatibility.

FIG. 4C: SECURE PROPAGATION

Propagation is secured with adaptable cryptography in secure execution environments. The module prevents tampering across ecosystems. It future-proofs interoperability.

FIG. 4D: FORK RESOLUTION PROCESS

The process determines canonical states across blockchain forks, logged for EoU. It enforces consistency for future architectures. The module maintains integrity.

FIG. 4E: COMPLIANCE SYNCHRONIZATION

Constraints are synchronized dynamically in secure execution environments. The module updates rules for future regulations. It ensures global adherence.

### Governance Control Interface

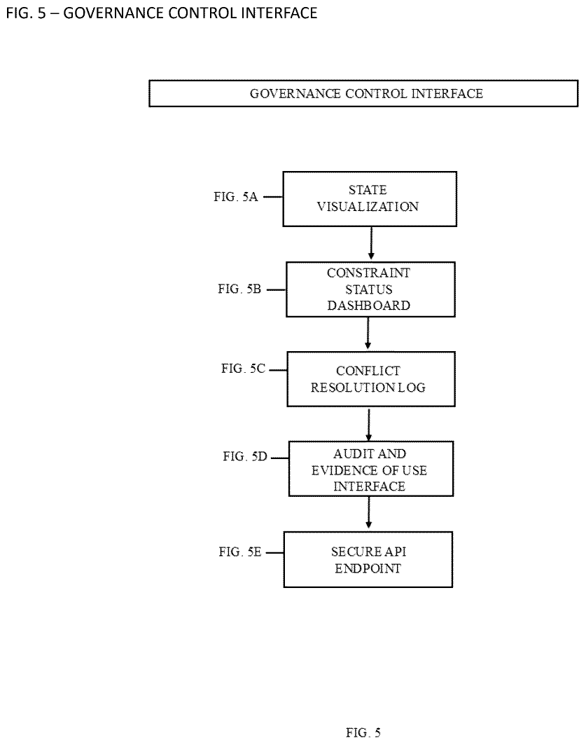

FIG. 5 shows the interface for state monitoring and control in secure execution environments. It rejects unauthorized inputs with EoU logging. The interface supports future technologies.

FIG. 5A: STATE VISUALIZATION

The interface displays states and transitions in real-time. It enhances clarity for operators across platforms. The module supports future interfaces.

FIG. 5B: CONSTRAINT STATUS DASHBOARD

The dashboard visualizes compliance and risk, highlighting rejected transitions. It supports monitoring for future systems. The module ensures operational transparency.

FIG. 5C: CONFLICT RESOLUTION LOG

The log displays conflict outcomes, logged for EoU. It records state freeze actions for transparency. The module adapts to future logging standards.

FIG. 5D: AUDIT AND EVIDENCE OF USE INTERFACE

The interface provides access to logs for audits and EoU. It ensures compliance with future standards. The module supports infringement detection.

FIG. 5E: SECURE API ENDPOINT

The endpoint delivers data via APIs with EOU logging. It restricts unauthorized access and supports future protocols. The module facilitates integration.

### Failure Modes and Degradation

The platform handles failure modes like data loss or subsystem failure. It defaults to Emergency Suspension to prevent unauthorized transitions, logged for audit and EOU. The system ensures compliance and integrity across future technologies.

### Protocol-Layer Rejection Embodiment

In one or more embodiments, cryptographic rejection is enforced at the protocol layer, preventing execution of non-compliant state transitions across all integrated ecosystems regardless of application-layer behavior. This ensures robust governance enforcement. The approach aligns with future protocol advancements.

### Machine-Time Enforcement

Conflict resolution and state enforcement occur at machine-time scales infeasible for human cognitive processing. This ensures deterministic and secure governance execution. The system is designed to adapt to future computational advancements.

1. A computer-implemented platform for unified adaptive governance across heterogeneous ecosystems, comprising: a governance state engine configured to maintain a finite set of governance states, including Normal Operation, Regulatory Constraint, Elevated Risk, Monetization-Restricted, and Emergency Suspension, with predefined allowed, prohibited, and irreversible state transitions executed within secure execution environments using cryptographically enforced signatures; a cross-ecosystem integration layer configured to propagate governance states between Web2 and Web3 platforms using application programming interfaces (APIs) with Evidence of Use (EoU) logging; a security module configured to enforce state transitions with cryptographic signatures adaptable to future standards; a constraint enforcement module configured to validate state transitions against regulatory, sustainability, and risk constraints, cryptographically rejecting non-compliant transitions; and a conflict resolution module configured to resolve conflicts between constraints and jurisdictions using a rule-based hierarchy with state freeze and rollback capabilities.

2. A method for unified adaptive governance across heterogeneous ecosystems, comprising: maintaining a finite set of governance states, including Normal Operation, Regulatory Constraint, Elevated Risk, Monetization-Restricted, and Emergency Suspension, with predefined allowed, prohibited, and irreversible state transitions executed within secure execution environments using cryptographically enforced signatures; propagating governance states between Web2 and Web3 platforms using APIs with EoU logging; enforcing state transitions with cryptographic signatures adaptable to future standards; validating state transitions against regulatory, sustainability, and risk constraints, cryptographically rejecting non-compliant transitions; and resolving conflicts between constraints and jurisdictions using a rule-based hierarchy with state freeze and rollback.

3. A non-transitory computer-readable medium storing instructions that, when executed by a processor, cause the processor to: maintain a finite set of governance states, including Normal Operation, Regulatory Constraint, Elevated Risk, Monetization-Restricted, and Emergency Suspension, with predefined allowed, prohibited, and irreversible state transitions executed within secure execution environments using cryptographically enforced signatures; propagate governance states between Web2 and Web3 platforms using APIs with EoU logging; enforce state transitions with cryptographic signatures adaptable to future standards; validate state transitions against regulatory, sustainability, and risk constraints, cryptographically rejecting non-compliant transitions; and resolve conflicts between constraints and jurisdictions using a rule-based hierarchy with state freeze and rollback.

4. The platform of claim 1, wherein the governance state engine includes an override mechanism allowing manual state transitions under emergency conditions within secure execution environments, logged for audit and EoU.

5. The platform of claim 1, wherein the cross-ecosystem integration layer harmonizes data schemas using ontology-based cosine similarity with EoU logging.

6. The platform of claim 1, wherein the constraint enforcement module validates transitions against regulatory and sustainability constraints, ensuring compliance with global standards.

7. The platform of claim 1, wherein the conflict resolution module prioritizes regulatory constraints, freezing states for irreconcilable jurisdictional conflicts, logged for EoU.

8. The platform of claim 1, further comprising a bounded AI subsystem proposing state transitions within constraint envelopes in secure execution environments, discarded without execution if constraints fail, logged for EoU.

9. The platform of claim 1, further comprising a monetization subsystem licensing state data via blockchain-based smart contracts, blocked for non-compliant states, logged for EoU.

10. The platform of claim 1, wherein enforcement of irreversible state transitions requires execution within a hardware-isolated secure execution environment.
